(19) United States
(12) Patent Application Publication
(10) Pub. No.: US 2026/0097948 A1
(43) Pub. Date: Apr. 9, 2026

(54) STEP APPARATUS FOR LIFT DEVICE WITH EXTENDABLE RAIL

(71) Applicant: Oshkosh Corporation, Oshkosh, WI (US)

(72) Inventor: Devin Rosencrance, Oshkosh, WI (US)

(73) Assignee: Oshkosh Corporation, Oshkosh, WI (US)

(21) Appl. No.: 19/351,163

(22) Filed: Oct. 6, 2025

Related U.S. Application Data
(60) Provisional application No. 63/704,315, filed on Oct. 7, 2024.
(60) Provisional application No. 63/704,329, filed on Oct. 7, 2024.

(51) Int. Cl. B66F 17/00

(52) U.S. Cl. CPC B66F 17/006

(57) ABSTRACT

A deck apparatus for a lift device includes a frame, a deck, a member, and multiple rails. The deck is pivotally coupled with the frame. The member is coupled with the frame and is configured to translate along the frame in an upwards direction or a downwards direction. The rails are coupled to an upper end of the member. The rails define a perimeter and are coupled with the upper end of the member at a pair of corners. The rails include outer members and an extendable rail. The extendable rail includes ends configured to be received within inner volumes of the outer members. The extendable rail is configured to be extended from or retracted into the outer members to adjust a length of the perimeter of the rails.

### CROSS-REFERENCE TO RELATED PATENT APPLICATION

This application claims the benefit of and priority to (i) U.S. Provisional Application No. 63/704,315, filed Oct. 7, 2024, and (ii) U.S. Provisional Application No. 63/704,329, filed Oct. 7, 2024, the entire disclosures both of which are incorporated by reference herein.

### BACKGROUND

The present disclosure relates lift devices. More specifically, the present disclosure relates to storage structure for lift devices.

### SUMMARY

One embodiment of the present disclosure a deck apparatus for a lift device. The deck apparatus includes a frame, a deck, a member, and multiple rails. The deck is pivotally coupled with the frame. The member is coupled with the frame and is configured to translate along the frame in an upwards direction or a downwards direction. The rails are coupled to an upper end of the member. The rails define a perimeter and are coupled with the upper end of the member at a pair of corners. The rails include outer members and an extendable rail. The extendable rail includes ends configured to be received within inner volumes of the outer members. The extendable rail is configured to be extended from or retracted into the outer members to adjust a length of the perimeter of the rails.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a boom lift, according to some embodiments.

FIG. 2 is a perspective view of a scissors lift, according to some embodiments.

FIG. 3 is a perspective view of a platform assembly of the boom lift of FIG. 1 or the scissors lift of FIG. 2, according to some embodiments.

FIG. 4 is a side view of a platform assembly of the boom lift of FIG. 1 or the scissors lift of FIG. 2 including an extendable deck, according to some embodiments.

FIG. 5 is a perspective view of a deployable step assembly of the platform of FIG. 3 or FIG. 4 in a stowed position, according to some embodiments.

FIG. 6 is a perspective view of the deployable step assembly of the platform of FIG. 3 or FIG. 4 in a deployed position, according to some embodiments.

FIG. 7 is a perspective side view of the deployable step assembly in a stowed position, according to some embodiments.

FIG. 8 is a perspective side view of the deployable step assembly in a partially deployed position, according to some embodiments.

FIG. 9 is a front perspective view of the deployable step assembly in the deployed position, according to some embodiments.

FIG. 10 is a rear perspective view of the deployable step assembly in the deployed position, according to some embodiments.

FIG. 11 is a perspective view of a step of the deployable step assembly, according to some embodiments.

FIG. 12 is a bottom perspective view of a portion of the deployable step assembly showing a gas spring between a frame and a movable member, according to some embodiments.

FIG. 13 is a front perspective view of a portion of the deployable step assembly showing a bottom of the gas spring, according to some embodiments.

FIG. 14 is a front view of an upper portion of the deployable step assembly showing the movable member and the frame, according to some embodiments.

FIG. 15 is a rear view of the upper portion of the deployable step assembly showing the movable member and the frame, according to some embodiments.

FIG. 16 is a perspective view of the frame, the movable member, and a housing of the deployable step assembly, according to some embodiments.

FIG. 17 is a diagram of the deployable step assembly in a stowed position, according to some embodiments.

FIG. 18 is a diagram of the deployable step assembly in a deployed position, according to some embodiments.

FIG. 19 is a perspective view of a rail of the deployable step assembly, according to some embodiments.

FIG. 20 is a perspective view of the rail of the deployable step assembly, according to some embodiments.

FIG. 21 is a top view of the rail of the deployable step assembly that can be telescoped between a retracted and a deployed position, according to some embodiments.

FIG. 22 is a front view of the rail of the deployable step assembly with the rail in a closed position, according to some embodiments.

FIG. 23 is a front view of the rail of the deployable step assembly with the rail in an open position, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, a deployable step assembly is provided on a platform of a lift device. The deployable step assembly includes a frame, a movable member, a step, a cable, a gas spring damper, and a rail. The rail is disposed on the movable member. The movable member is coupled with the frame such that the movable member is configured to be moved in an upwards or a downwards direction along the frame. The step is hingedly coupled with the frame such that the step can be rotated between a stowed position and a deployed position. The step can be coupled with the cable such that movement of the step between the stowed position and the deployed position drives the cable. The cable is coupled at an opposite end with the movable member such that rotational motion of the step from the stowed position to the deployed position causes the movable member to move in the upwards direction. Likewise, moving the step from the deployed position to the stowed position causes the movable member to move in the downwards direction. The gas spring damper is coupled at a first end with the movable member and a second end with the frame. The gas spring damper is configured to bias the movable member into a downwards position, corresponding to the step in the stowed position. The movable member can be selectably pinned to the frame when the movable member is in an upper or lower position (e.g., corresponding to the deployed or stowed position of the step). If the movable member is in the upper position and the pin is removed from the frame and the movable member, the gas spring damper drives movement of the movable member, thereby causing the step to transition into the stowed position.

The movable member includes a plurality of rails disposed at a top. The plurality of rails can form a perimeter or square. The rails can be coupled with the movable member at a top of the movable member at a pair of adjacent corners. The rails can protrude in a direction perpendicular to the top of the movable member. The rails can include outer members and inner members that can telescope relative to the outer member to adjust a length of the rails. The inner members can be moved in order to provide sufficient clearance between the rails and an area directly above the rails. The inner members of the rails can be adjusted to a desired position with the movable member in the lower position.

The rails can also include a pivotal member that is hingedly coupled with a fixed portion of the rails. The pivotal member can be configured to abut a fixed portion of the rails at a free end. The pivotal member can include an opening configured to receive a pin that locks the pivotal member with the fixed portion of the rails. The pivotal member can be transitioned (e.g., rotated about the hinge) in order to allow access to the step once the step is deployed. The pivotal member can then be returned to the closed position and locked via the pin to provide a continuous perimeter of rails within which a user can work.

### Boom Lift

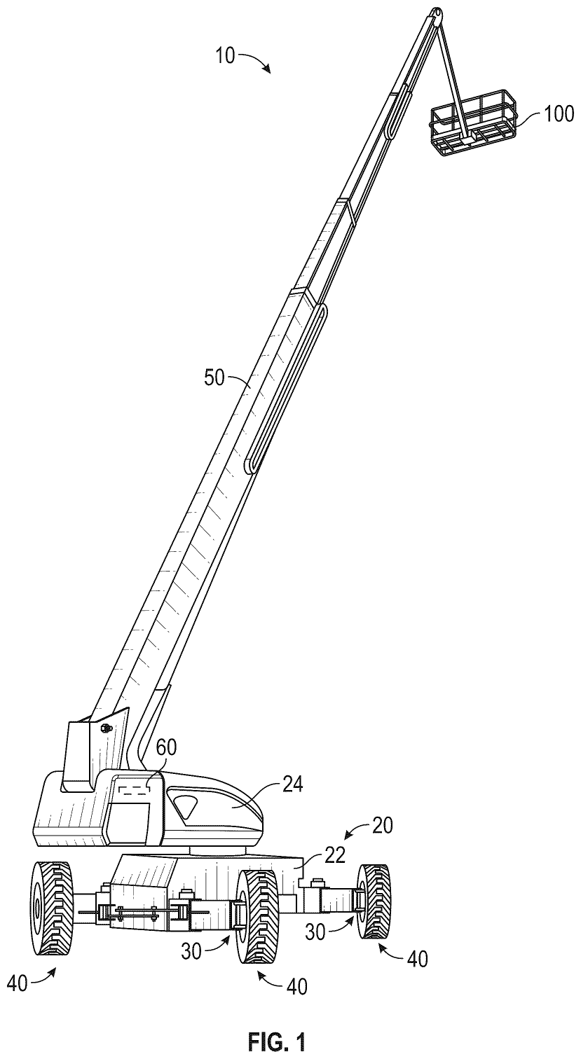

According to the exemplary embodiment shown in FIG. 1, a lift device (e.g., a boom, a telehandler, etc.), shown as lift device 10, includes a chassis, shown as chassis 20. According to an exemplary embodiment, the chassis 20 includes a frame, shown as frame 22. As shown in FIG. 1, the lift device includes a series of axles, shown as axles 30, coupled to the frame 22. In one embodiment, the lift device 10 includes a plurality of independent axles 30 (e.g., four, etc.) coupled to the frame 22. In another embodiment, the lift device 10 includes a first solid axle 30 coupled to a front end of the frame 22 and a second solid axle 30 coupled to a rear end of the frame 22. A wheel assembly (e.g., a wheel and tire assembly), shown as wheel assembly 40, is coupled to an end of each axle 30. The lift device 10 may include one or more actuators (e.g., hydraulic cylinders) to rotate the axles 30 relative to the frame 22 and/or to rotate the wheel assemblies 40 relative to the axles 30 (e.g., about respective vertical axes). This may facilitate varying the wheelbase of the lift device. The wheel assemblies 40 may include one or more actuators to drive the wheels and propel the lift device 10.

As shown in FIG. 1, the lift device 10 includes a lift assembly, shown as lift boom 50. In some embodiments, the lift boom 50 is rotatably coupled to the chassis 20. As shown in FIG. 1, the lift boom 50 is directly, pivotally coupled to a turntable 24 (e.g., such that the lift boom 50 rotates relative to the turntable 24 about a horizontal axis). The turntable 24 is rotatably coupled to the frame 22 (e.g., such that the lift boom 50 and the turntable 24 rotate relative to the frame 22 about a vertical axis). Rotation of the turntable 24 may be facilitated by a bearing disposed between the turntable 24 and the frame 22. As shown in FIG. 1, an operational device (e.g., an aerial work platform), shown as platform 100, is coupled to an end of the lift boom 50 opposite the frame 22.

Referring still to FIG. 1, the lift boom 50 includes a plurality of telescoping boom sections. An actuator may extend the plurality of telescoping boom sections to increase the extension length of the lift boom 50 (e.g., during operation of the lift device 10 by an operator aboard the platform 100, etc.). According to the exemplary embodiment shown in FIG. 1, the lift boom 50 is pivotally coupled to the turntable 24 such that the platform 100 may be elevated relative to a ground surface. In one embodiment, an actuator pivots the lift boom 50 upward, thereby increasing a working height of the platform 100.

As shown in FIG. 1, the lift device 10 includes a controller 60. The controller 60 is configured to facilitate various operations of the lift device 10. By way of example, the controller 60 may be configured to provide command signals relating to the rotation of the turntable 24 and the lift boom 50 relative to the frame 22, the extension of the lift boom 50, and the rotation of at least one of the wheel assemblies 40 (e.g., to drive the lift device 10, etc.). The controller 60 may also be configured to engage at least one actuator to facilitate movement of at least one of the wheel assemblies 40, the turntable 24, the lift boom 50, and the platform 100. By way of another example, the controller 60 may be communicably coupled with an operator input/output (I/O) device (e.g., a user interface) such that an operator of the lift device 10 may provide a variety of commands to the controller 60.

In other embodiments, the platform 100 is used with a different lift device or vehicle. By way of example, the platform 100 may be used with a boom lift, a scissor lift, a vertical lift, a telehandler outfitted with an operator platform, a crane, or another lift device. In yet other embodiments, the platform 100 is a fixed, stationary, or immobile platform, such as a catwalk, a scaffold, or a floor of a building.

### Scissors Lift

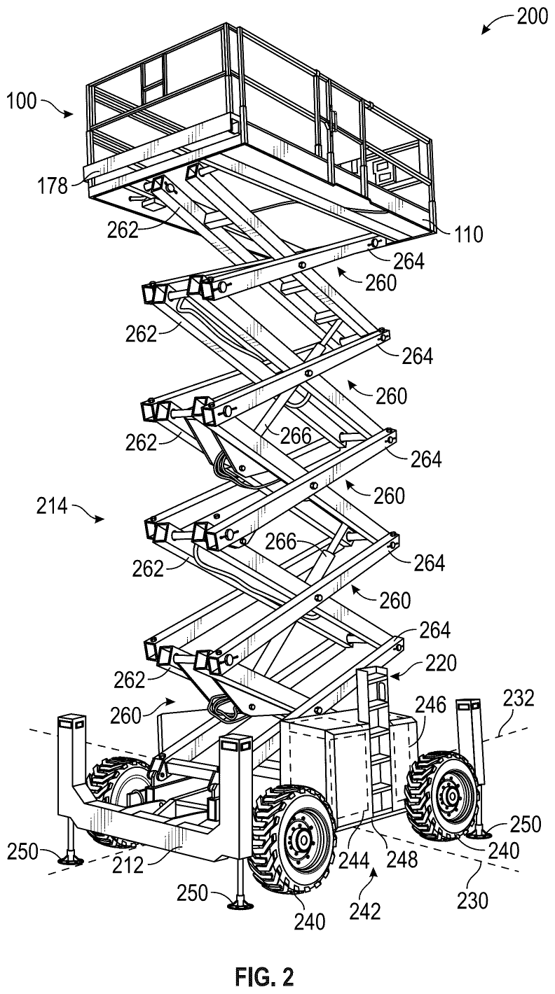

According to the exemplary embodiment shown in FIG. 2, a lift device (e.g., a scissor lift, an aerial work platform, a boom lift, a telehandler, etc.), shown as scissors lift 200, includes a chassis, shown as frame assembly 212. A lift device (e.g., a scissor assembly, a boom assembly, etc.), shown as lift assembly 214, couples the frame assembly 212 to a platform, shown as platform 100. The frame assembly 212 supports the lift assembly 214 and the platform 100, both of which are disposed directly above the frame assembly 212. In use, the lift assembly 214 extends and retracts to raise and lower the platform 100 relative to the frame assembly 212 between a lowered position and a raised position. The scissors lift 200 includes an access assembly, shown as an access assembly 220, that is coupled to the frame assembly 212 and configured to facilitate access to the platform 100 from the ground by an operator when the platform 100 is in the lowered position.

Referring again to FIG. 2, the frame assembly 212 defines a horizontal plane having a lateral axis 230 and a longitudinal axis 232. In some embodiments, the frame assembly 212 is rectangular, defining lateral sides extending parallel to the lateral axis 230 and longitudinal sides extending parallel to the longitudinal axis 232. In some embodiments, the frame assembly 212 is longer in a longitudinal direction than in a lateral direction. In some embodiments, the scissors lift 200 is configured to be stationary or semi-permanent (e.g., a system that is installed in one location at a work site for the duration of a construction project). In such embodiments, the frame assembly 212 may be configured to rest directly on the ground and/or the scissors lift 200 may not provide powered movement across the ground. In other embodiments, the scissors lift 200 is configured to be moved frequently (e.g., to work on different tasks, to continue the same task in multiple locations, to travel across a job site, etc.). Such embodiments may include systems that provide powered movement across the ground.

Referring to FIG. 2, the scissors lift 200 is supported by a plurality of tractive assemblies 240, each including a tractive element (e.g., a tire, a track, etc.), that are rotatably coupled to the frame assembly 212. The tractive assemblies 240 may be powered or unpowered. As shown in FIG. 2, the tractive assemblies 240 are configured to provide powered motion in the direction of the longitudinal axis 232. One or more of the tractive assemblies 240 may be turnable to steer the scissors lift 200. In some embodiments, the scissors lift 200 includes a powertrain system 242. In some embodiments, the powertrain system 242 includes a primary driver 244 (e.g., an engine). A transmission may receive the mechanical energy and provide an output to one or more of the tractive assemblies 240. In some embodiments, the powertrain system 242 includes a pump 246 configured to receive mechanical energy from the primary driver 244 and output a pressurized flow of hydraulic fluid. The pump 246 may supply mechanical energy (e.g., through a pressurized flow of hydraulic fluid) to individual motive drivers (e.g., hydraulic motors) configured to facilitate independently driving each of the tractive assemblies 240. In other embodiments, the powertrain system 242 includes an energy storage device (e.g., a battery, capacitors, ultra-capacitors, etc.) and/or is electrically coupled to an outside source of electrical energy (e.g., a standard power outlet). In some such embodiments, one or more of the tractive assemblies 240 include an individual motive driver (e.g., a motor that is electrically coupled to the energy storage device, etc.) configured to facilitate independently driving each of the tractive assemblies 240. The outside source of electrical energy may charge the energy storage device or power the motive drivers directly. The powertrain system 242 may additionally or alternatively provide mechanical energy (e.g., using the pump 246, by supplying electrical energy, etc.) to one or more actuators of the scissors lift 200 (e.g., the leveling actuators 250, the lift actuators 266, etc.). One or more components of the powertrain system 242 may be housed in an enclosure, shown as housing 248. The housing 248 is coupled to the frame assembly 212 and extends from a side of the scissors lift 200 (e.g., a left or right side). The housing 248 may include one or more doors to facilitate access to components of the powertrain system 242.

In some embodiments, the frame assembly 212 is coupled to one or more actuators, shown in FIG. 2 as leveling actuators 250. The scissors lift 200 includes four leveling actuators 250, one in each corner of the frame assembly 212. The leveling actuators 250 extend and retract vertically between a stored position and a deployed position. In the stored position, the leveling actuators 250 are raised and do not contact the ground. In the deployed position, the leveling actuators 250 contact the ground, lifting the frame assembly 212. The length of each of the leveling actuators 250 in their respective deployed positions may be varied to adjust the pitch (i.e., rotational position about the lateral axis 230) and the roll (i.e., rotational position about the longitudinal axis 232) of the frame assembly 212. Accordingly, the lengths of the leveling actuators 250 in their respective deployed positions may be adjusted such that the frame assembly 212 is leveled with respect to the direction of gravity, even on uneven or sloped terrains. The leveling actuators 250 may additionally lift the tractive elements of the tractive assemblies 240 off the ground, preventing inadvertent driving of the scissors lift 200.

Referring to FIG. 2, the lift assembly 214 includes a number of subassemblies, shown as scissor layers 260, each including a first member, shown as inner member 262, and a second member, shown as outer member 264. In each scissor layer 260, the outer member 264 receives the inner member 262. The inner member 262 is pivotally coupled to the outer member 264 near the centers of both the inner member 262 and the outer member 264. Accordingly, inner member 262 pivots relative to the outer member 264 about a lateral axis. The scissor layers 260 are stacked atop one another to form the lift assembly 214. Each inner member 262 and each outer member 264 has a top end and a bottom end. The bottom end of each inner member 262 is pivotally coupled to the top end of the outer member 264 immediately below it, and the bottom end of each outer member 264 is pivotally coupled to the top end of the inner member 262 immediately below it. Accordingly, each of the scissor layers 260 are coupled to one another such that movement of one scissor layer 260 causes a similar movement in all of the other scissor layers 260. The bottom ends of the inner member 262 and the outer member 264 belonging to the lowermost of the scissor layers 260 are coupled to the frame assembly 212. The top ends of the inner member 262 and the outer member 264 belonging to the uppermost of the scissor layers 260 are coupled to the platform 100. The inner members 262 and/or the outer members 264 are slidably coupled to the frame assembly 212 and the platform 100 to facilitate the movement of the lift assembly 214. Scissor layers 260 may be added to or removed from the lift assembly 214 to increase or decrease, respectively, the maximum height that the platform 100 is configured to reach.

One or more actuators (e.g., hydraulic cylinders, pneumatic cylinders, motor-driven leadscrews, etc.), shown as lift actuators 266, are configured to extend and retract the lift assembly 214. As shown in FIG. 2, the lift assembly 214 includes a pair of lift actuators 266. Lift actuators 266 are pivotally coupled to an inner member 262 at one end and pivotally coupled to another inner member 262 at the opposite end. These inner members 262 belong to a first scissor layer 260 and a second scissor layer 260 that are separated by a third scissor layer 260. In other embodiments, the lift assembly 214 includes more or fewer lift actuators 266 and/or the lift actuators 266 are otherwise arranged. The lift actuators 266 are configured to actuate the lift assembly 214 to selectively reposition the platform 100 between the lowered position, where the platform 100 is proximate the frame assembly 212, and the raised position, where the platform 100 is at an elevated height. In some embodiments, extension of the lift actuators 266 moves the platform 100 vertically upward (extending the lift assembly 214), and retraction of the linear actuators moves the platform 100 vertically downward (retracting the lift assembly 214). In other embodiments, extension of the lift actuators 266 retracts the lift assembly 214, and retraction of the lift actuators 266 extends the lift assembly 214. In some embodiments, the outer members 264 are approximately parallel and/or contacting one another when with the lift assembly 214 in a stored position. The scissors lift 200 may include various components to drive the lift actuators 266 (e.g., pumps, valves, compressors, motors, batteries, voltage regulators, etc.).

Referring again to FIG. 2, the platform 100 includes a support surface, shown as base 110, defining a top surface configured to support operators and/or equipment and a bottom surface opposite the top surface. The bottom surface and/or the top surface extend in a substantially horizontal plane. A thickness of the base 110 is defined between the top surface and the bottom surface. The bottom surface is coupled to a top end of the lift assembly 214. In some embodiments, the base 110 is rectangular. In some embodiments, the base 110 has a footprint that is substantially similar to that of the frame assembly 212.

Referring again to FIG. 2, the platform 100 further includes one or more platforms, shown as extendable decks 178, that are received by the base 110 and that each define a top surface. The extendable decks 178 are selectively slidable relative to the base 110 between an extended position and a retracted position. In the retracted position, shown in FIG. 2, the extendable decks 178 are completely or almost completely received by the base 110. In the extended position, the extendable decks 178 project outward (e.g., longitudinally, laterally, etc.) relative to the base 110 such that their top surfaces are exposed. With the extendable decks 178 projected, the top surfaces of the extendable decks 178 and the top surface of the base 110 are all configured to support operators and/or equipment, expanding the supported area. In some embodiments, the extendable decks 178 include guard rails partially or fully enclose the supported area. The extendable decks 178 facilitate accessing areas that are spaced outward from the frame assembly 212.

### Platform

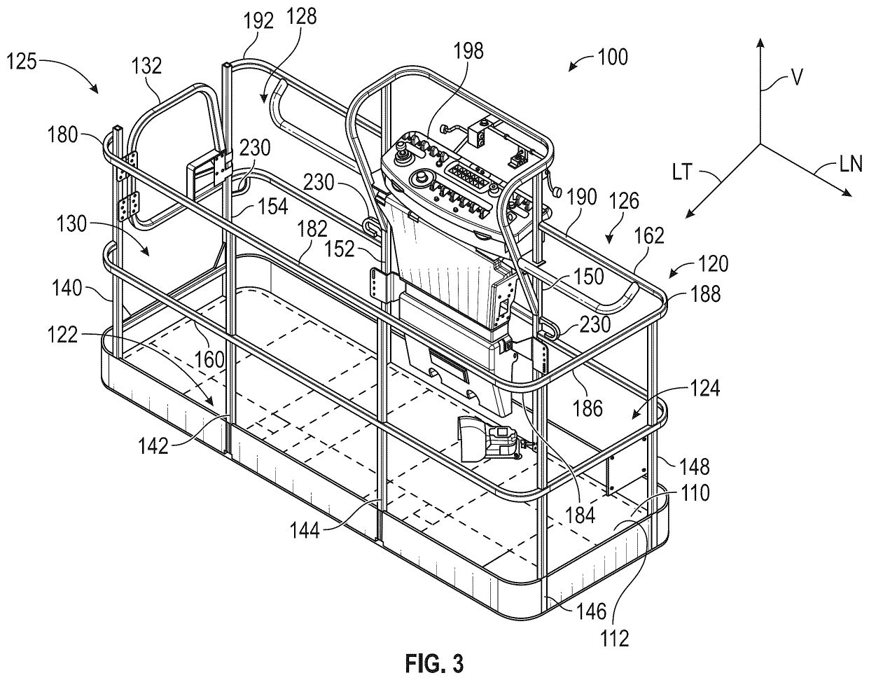

Referring to FIG. 3, the platform 100 is shown according to an exemplary embodiment. The platform 100 is configured to support an operator while elevated above the ground. The operator may perform one or more tasks while supported by the platform 100, or the operator may use the platform 100 to reach an elevated surface and subsequently exit the platform 100. A vertical axis V, a lateral axis LT, and a longitudinal axis LN are defined with respect to the platform.

The platform 100 includes a flat support surface, base, or platform, shown as base 110. A top surface of the base 110 (i.e., a support surface 112) is configured to support one or more operators. The support surface 112 may be a continuous, substantially flat surface, or the support surface 112 may include multiple sections that are separated from one another by one or more obstructions (e.g., a gap, a protrusion, etc.). By way of example, the base 110 may include one or more sheets of expanded metal.

The platform 100 further includes a hand railing, rail, handrail, handrail, guiderail, or boundary assembly, shown as handrail 120. The handrail 120 is configured to provide support for an operator and to prevent the operator from falling off of the platform 100. The handrail 120 is fixedly coupled to the base 110 and extends upward, above the support surface 112. The handrail 120 extends along a perimeter of the base 110. Specifically, as shown in FIG. 2, the handrail 120 includes a front portion 122 extending along a front side of the base 110, a right portion 124 extending along a right side of the base 110, and a rear portion 126 extending along the rear side of the base 110. As shown, the front portion 122, the right portion 124, and the rear portion 126 are continuous with one another. In other embodiments, the front portion 122, the right portion 124, and/or the rear portion 126 are (a) separated by one or more gaps, (b) made up of multiple sections, and/or (c) omitted. A volume, shown as working area 128, is defined between the base 110, the front portion 122, the right portion 124, and the rear portion 126. The working area 128 defines an area in which an operator can stand upon the base 110 while being contained within the handrail 120.

An aperture, gap, or opening, shown as doorway 130, is defined at the left side of the base 110 between the front portion 122 and the rear portion 126. A door or gate, shown as gate 132, selectively extends across the doorway 130 to prevent passage of the operator through the doorway 130. Specifically, the gate 132 is pivotally coupled to the front portion 122 (e.g., by a hinge) and selectively coupled to the rear portion 126 (e.g., by a latch).

The handrail 120 includes a series of upright members (e.g., members that are substantially vertical when the base 110 is level) and a series of horizontal members (e.g., members that are substantially horizontal when the base 110 is level). The upright members are approximately evenly spaced along the perimeter of the base 110 and fixedly coupled to the base 110. Specifically, proceeding counterclockwise as viewed from above, the handrail 120 includes the following upright members: upright member 140, upright member 142, upright member 144, upright member 146, upright member 148, upright member 150, upright member 152, and upright member 154. The handrail 120 includes a first horizontal member, shown as middle rail 160, and a second horizontal member or handrail, shown as top rail 162. The middle rail 160 is positioned between the top rail 162 and the base 110. The top rail 162 defines a top surface of the handrail 120. Each horizontal member or vertical member may include a single member or multiple members that are substantially aligned with one another. By way of example, the upright member 154 includes a single, continuous member, whereas the upright member 144 is bisected by the middle rail 160.

As shown, the top rail 162 includes a series of curved and straight sections that are arranged in a generally C-shape extending from the upright member 140 to the upright member 154. A first curved section 180 is coupled to a top end portion of the first upright member 140. A first straight section 182 extends in a longitudinal direction from the first curved section 180 to a second curved section 184. The first straight section 182 is coupled to top end portions of the upright member 142 and the upright member 144. A second straight section 186 extends between the second curved section 184 and a third curved section 188. The second straight section 186 is coupled to top end portions of the upright member 146 and the upright member 148. A third straight section 190 extends between the third curved section 188 and a fourth curved section 192. The third straight section 190 is formed in two parts, each part being coupled to a middle section of the upright member 150 or the upright member 152. The fourth curved section 192 is coupled to the upright member 154. As shown, each curved section is curved approximately 90 degrees.

The platform 100 provides a surface upon which operators stand while operating the lift device 10 with an I/O device 198. Specifically, the I/O device 198 is coupled to the handrail 120 between the upright member 150 and the upright member 152. The I/O device 198 faces inward such that it can be used by an operator standing within the working area 128. In one embodiment, the I/O device 198 is communicably coupled to various components of the lift device 10 (e.g., the wheel assemblies 40, the turntable 24, the lift boom 50, the platform 100, the controller 60, etc.) such that information or signals (e.g., command signals, etc.) may be exchanged to and from the I/O device 198. By way of example, the I/O device 198 may include at least one of an interactive display, a touchscreen device, one or more buttons, joysticks, switches, and/or voice command receivers. An operator may use a joystick associated with the I/O device 198 to trigger the engagement of an actuator positioned to turn one of the wheel assemblies 40, thereby turning the lift device 10 towards a desired location. By way of another example, an operator may engage a lever associated with the I/O device 198 to trigger the extension or retraction of the plurality of sections of the lift boom 50.

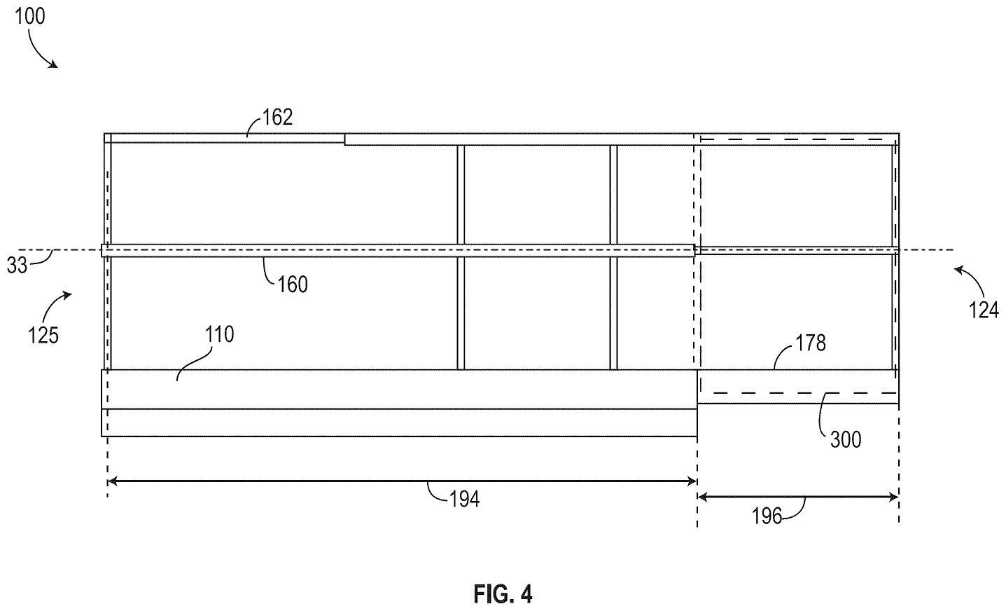

Referring to FIG. 4, the extendable deck 178 can be extended in a longitudinal direction along longitudinal axis 33. The extendable deck 178 can telescope from the base 110. The platform 100 can include telescoping upper rails 162 and middle rails 160 such that the upper rails 162 and the middle rails 160 of the extendable deck 178 telescope as the extendable deck 178 is extended or retracted. The extendable deck 178 can also protrude from a lateral side of the platform 100. The extendable deck 178 can be disposed on the right portion 124 or a left portion 125 of the platform 100. The extendable deck 178 can define an end of the platform 100. When the extendable deck 178 is fully retracted, the platform 100 has an overall length 194. The extendable deck 178 can be transitioned or moved into the extended position an additional length 196.

The extendable deck 178 can include a deployable step assembly 300 that is a part of the extendable deck 178. In some embodiments, the deployable step assembly 300 is coupled to a portion of the extendable deck 178 (e.g., coupled to the middle rails 160 and the upper rails 162). In some embodiments, the deployable step assembly 300 is coupled to rails of the platform 100 of the scissors lift 200 or the boom 10. In some embodiments, the deployable step assembly 300 forms an end of the platform 100 (e.g., a longitudinal end shown as right portion 124 or left portion 125).

### Deployable Deck

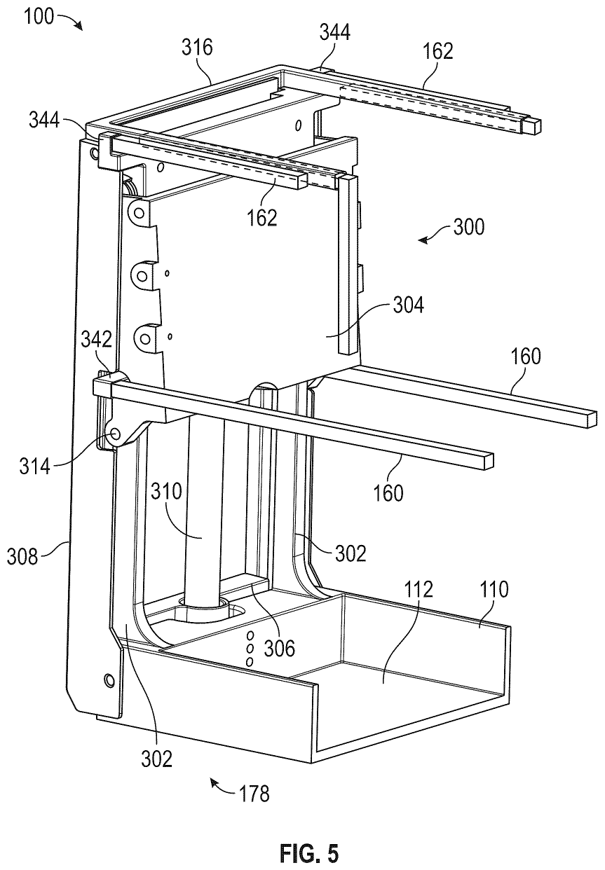

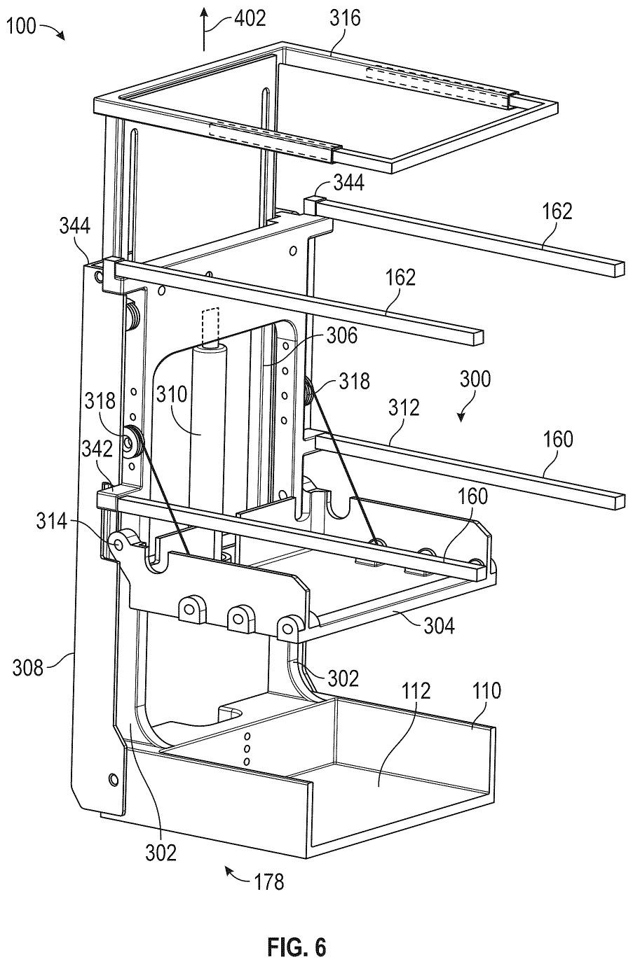

Referring to FIGS. 5 and 6, among others, the deployable step assembly 300 (e.g., a deployable deck assembly, a deck apparatus, a step apparatus, etc.) includes a frame 302 (e.g., vertically extending members, a fixed member, an anchored member, a body, etc.), a step 304, a movable member 306, a gas shock 310 (e.g., a damper, a cylinder, a gas-spring damper, a gas spring, a spring, a resilient member, a spring-damper assembly, etc.), and a housing 308. The step 304 is pivotally coupled (e.g., via a hinge 314) with the frame 302. The gas shock 310 is fixedly coupled at a first end with the movable member 306, and fixedly coupled at a second end with the frame 302. The movable member 306 is positioned between the frame 302 and the housing 308. The movable member 306 is slidably coupled with the frame 302. The movable member 306 is configured to translate relative to the frame 302 which remains stationary. The movable member 306 is positioned on a first side of the frame 302. The step 304 is pivotally coupled with the frame 302 and protrudes from a second side of the frame 302 opposite the first side on which the movable member 306 is disposed. The housing 308 is disposed on the first side of the frame 302 and defines a space between an interior surface of the housing 308 and the frame 302 within which the movable member 306 is positioned. The movable member 306 is configured to translate in an upwards and downwards direction relative to both the frame 302 and the housing 308 from and into the space between the interior surface of the housing 308 and the frame 302.

As shown in FIG. 6, among others, the deployable step assembly 300 includes a cable 312. The cable 312 is coupled with a portion of the step 304. The cable 312 is also coupled with the movable member 306. The cable 312 operably couples the step 304 with the movable member 306. The cable 312 is configured to transfer rotational motion of the step 304 about its hinge point at hinge 314 on the frame 302 into translational motion of the movable member 306.

Referring still to FIGS. 5 and 6, among others, the step 304 is movable between a stowed position (as shown in FIG. 5) and a deployed position (as shown in FIG. 6). The step 304 can be moved, by hand, in order to rotate about the hinge 314 from the stowed position to the deployed position. As the step 304 is rotated in direction 350 about the hinge 314 from the stowed position to the deployed position, the movement of the step 304 drives translation of the movable member 306 in an upwards direction 402 through cable 312.

As shown in FIGS. 5-6, among others, the movable member 306 includes frame rails 316. The frame rails 316 can be provided as tubular members. The frame rails 316 provide surfaces for a user to grasp (e.g., while using the step 304). The frame rails 316 can define a perimeter (e.g., a rectangular or square perimeter) and extend in multiple directions. In some embodiments, the frame rails 316 are disposed in a plane that is parallel with the support surface 112. In some embodiments, one or more of the frame rails 316 extend in a lateral direction and one or more of the frame rails extend in a longitudinal direction (e.g., in directions parallel with the lateral axis LT and the longitudinal axis LN). For example, one or more of the frame rails 316 extend from an upper end of the movable member 306 in a same direction as the step 304 protrudes when in the deployed position.

As shown in FIGS. 5 and 6, among others, the gas shock 310 can bias the movable member 306 into a lower position corresponding to the stowed position of the step 304 (e.g., as shown in FIG. 5, among others). When the step 304 is moved into the deployed position as shown in FIG. 6 among others, the movable member 306 drives compression of the gas shock 310 and the gas shock 310 is compressed into a charged state or position (e.g., as shown in FIG. 6, among others). The gas shock 310 is configured to bias or drive movement of the step 304 out of the deployed position (as shown in FIG. 6, among others) and into the stowed position (as shown in FIG. 5, among others) by driving or biasing movement of the movable member 306 into the downwards direction (e.g., opposite the direction 402). The gas shock 310 automatically drives or biases transitioning the step 304 out of the deployed position and into the stowed position as shown in FIG. 5. The gas shock 310 can also dampen movement such that movement of the movable member 306 is dampened (e.g., in either the upwards direction 402 or the opposite downwards direction) and such that the movable member 306 and the step 304 move in a controlled and smooth manner. Advantageously, the gas shock 310 both biases the step 304 into the stowed position as shown in FIG. 5, among others, while ensuring controlled and smooth motion (e.g., such that the step 304 transitions into the stowed position at a controlled speed).

As shown in FIG. 6, the frame 302 includes pulleys (e.g., rotatable members, driven members, followers, spools, etc.), shown as pulleys 318. The pulleys 318 are rotatably coupled with the opposite sides of the frame 302. The cable 312 is engaged by the pulleys 318 at opposite sides of the frame 302. The cable 312, when drawn in either direction along the pulleys 318 can cause rotation of the pulleys 318. The pulleys 318 facilitate transferring mechanical energy (e.g., torque) from rotation of the step 304 into translational motion of the movable member 306 through the cable 312 (and vice versa). In some embodiments, the pulleys 318 are positioned at a vertical position along the frame 302 that is above a corresponding point at which the cable 312 couples with the movable member 306 such that the pulleys 318 facilitate the transfer of motion from the step 304 to the movable member 306. The pulleys 318 can include grooves or channels within which the cable 312 is received.

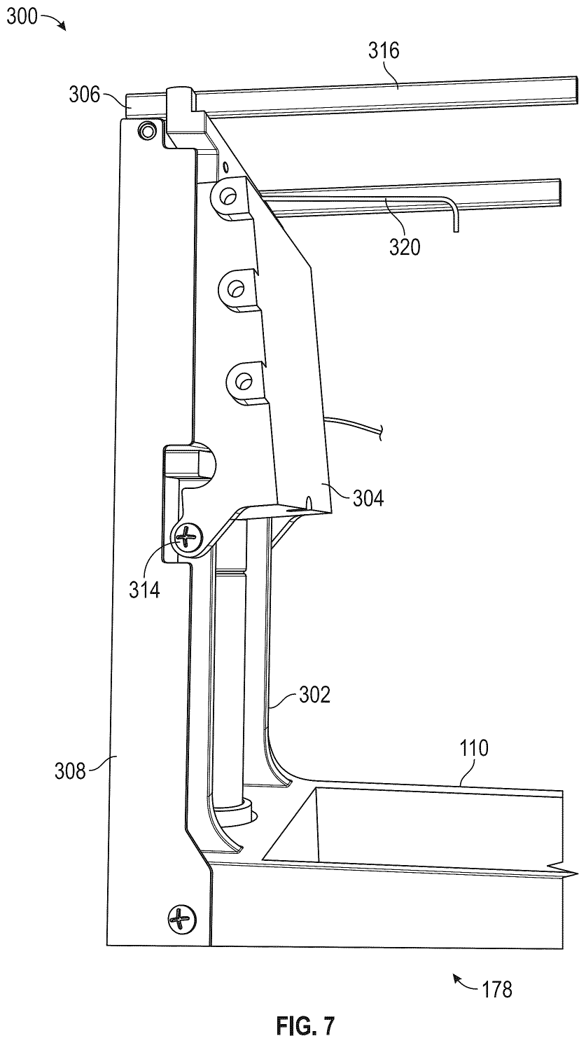

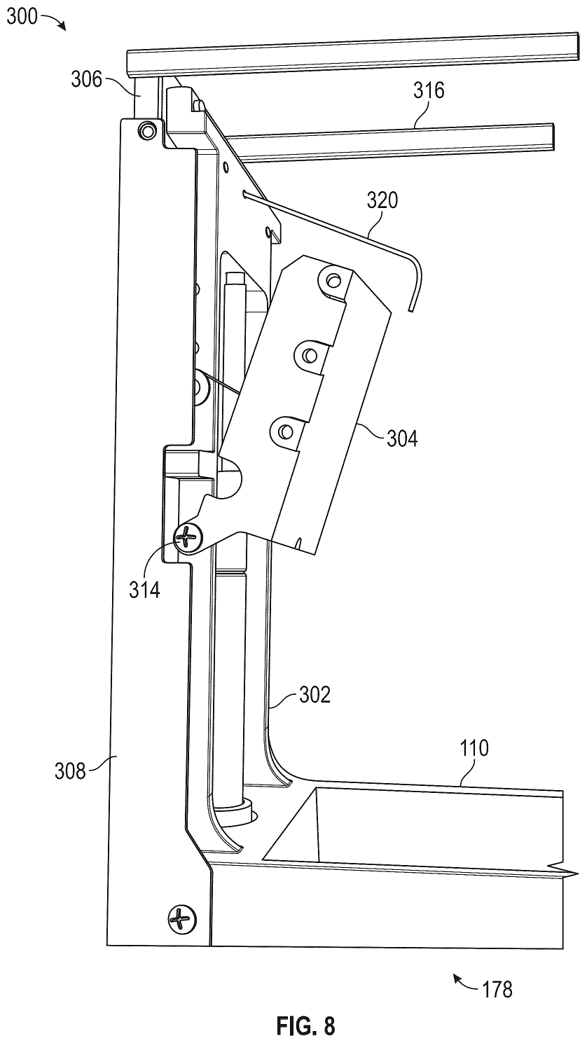

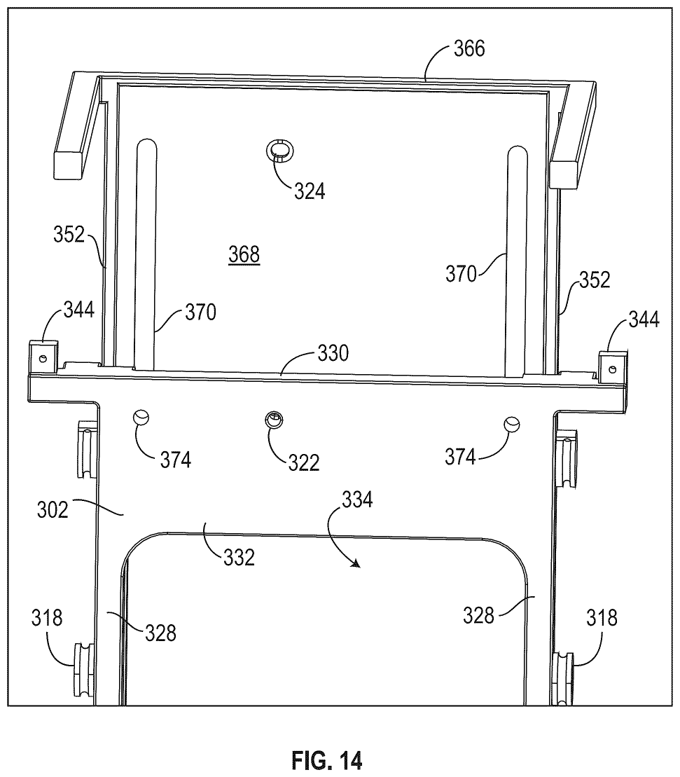

Referring to FIGS. 7-8, 10, 12, and 14-15, among others, the deployable step assembly 300 includes a pin 320. The pin 320 is configured to be inserted through an opening 322 (e.g., a hole, a bore, a through-hole an aperture) in the frame 302 and received within one of at least a first opening 324 or a second opening 326 of the movable member 306. The opening 322 can be accessible through a face 332 of an upper cross-member 330 of the frame 302. The first opening 324 and the second opening 326 of the movable member 306 are disposed at vertical positions along the movable member 306 corresponding to the stowed position and the deployed position of the step 304 (e.g., and the associated vertical position of the movable member 306 along the frame 302). When the deployable step assembly 300 is in the stowed configuration (shown in FIG. 5, among others), the pin 320 can be inserted through the opening of the frame 302 and into the first opening 324 of the movable member 306 in order to lock the deployable step assembly 300 in the stowed configuration (e.g., to limit movement of the movable member 306). When the deployable step assembly 300 is in the deployed configuration (shown in FIG. 6, among others), the pin 320 can be inserted through the opening of the frame 302 and into the second opening 326 of the movable member 306 in order to lock the deployable step assembly 300 in the deployed configuration (e.g., to limit movement of the movable member 306).

The pin 320 may be spring-loaded into engagement with the movable member 306. For example, the pin 320, when aligned with either the first opening 324 or the second opening 326, may automatically move into the first opening 324 or the second opening 326. The deployable step assembly 300 can be transitioned out of the stowed position by pulling the pin 320 out of the first opening 324 of the movable member 306, and rotating the step 304 about the hinges 314. Once the step 304 is fully deployed, the pin 320 can be inserted into the second opening 326 either manually or automatically by the spring-load. In order to transition the deployable step assembly 300 out of the deployed position and into the stowed position, the pin 320 may be removed from the second opening 326 (e.g., pulled outwards by a user). The step 304 then automatically transitions into the stowed position due to the bias of the gas shock 310.

It should be understood that the pin 320 as described herein to lock the deployable step assembly 300 is not intended to be limiting. For example, the deployable step assembly 300 may include interlocking geometry (e.g., spring loaded hooks, insertable members, etc.) in order to lock the deployable step assembly 300 in the deployed configuration or the deployed configuration.

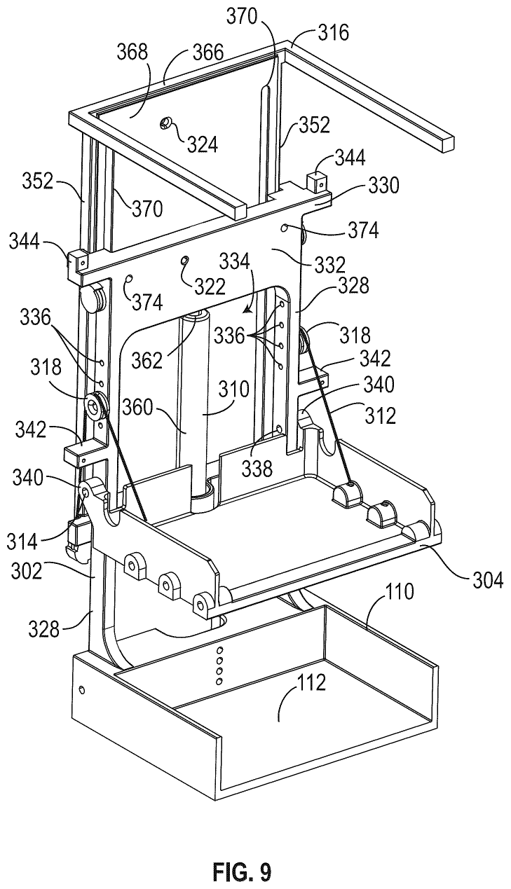

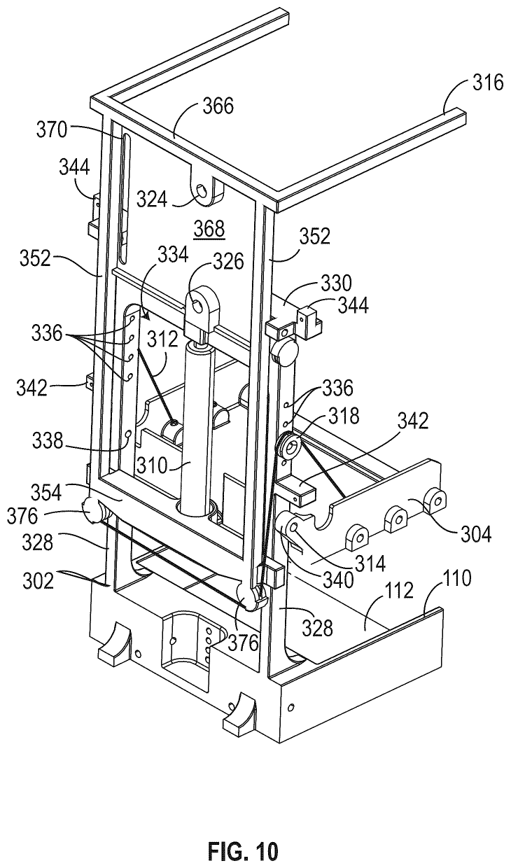

Referring to FIGS. 9-10, the frame 302 includes a pair of elongated members 328 that protrude upwards from the base 110. The elongated members 328 are substantially parallel with each other and can have the form of beams, bars, etc. The frame 302 includes the upper cross-member 330 at a top of the elongated members 328. The elongated members 328 are spaced apart from each other and define a space 334 (e.g., an opening) therebetween. The upper cross-member 330 extends between the elongated members 328 and defines an upper boundary of the frame 302. The elongated members 328 can be integrally formed or coupled (e.g., fastened) to the base 110 and protrude upwards. The space 334 can be defined between inwards facing surfaces of the elongated members 328 and a bottom surface of the upper cross-member 330.

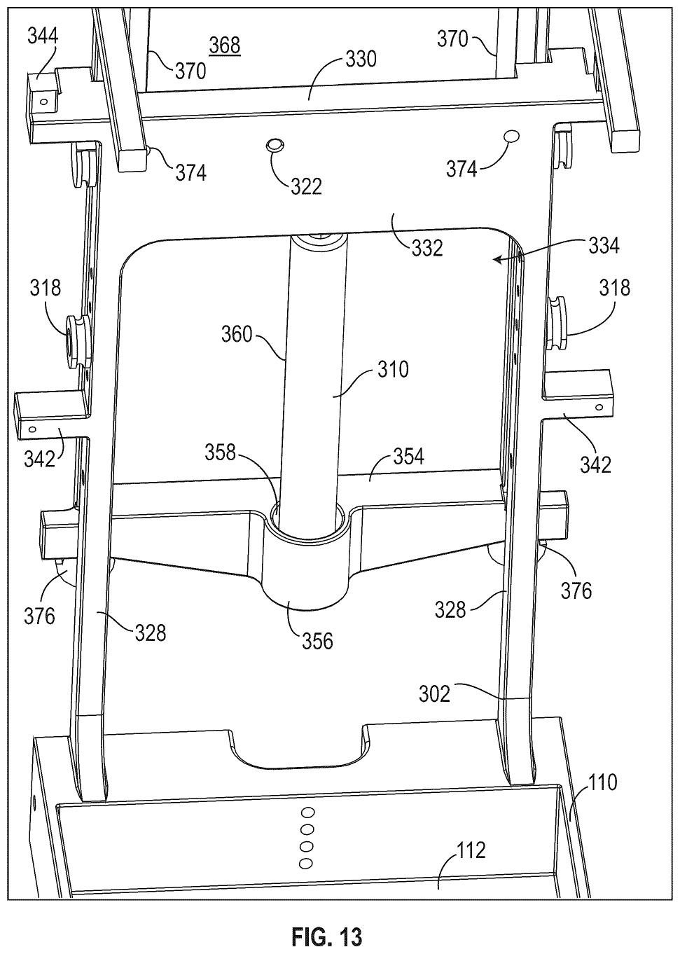

Referring to FIGS. 9-10, 12, 13, and 16, the pulleys 318 are disposed on outer surfaces of the elongated members 328. The pulleys 318 are rotatably coupled with the elongated members 328 at a position above the hinges 314. The pulleys 318 can be rotatably coupled through a pin or fastener that couples the pulleys 318 with the elongated members 328. The elongated members 328 include multiple openings 336 disposed at various vertical positions along the elongated members 328. The pulleys 318 can be adjustable between the multiple openings 336 to adjust a height of the pulleys 318 relative to the hinge 314 and adjust an angle at which the cable 312 is coupled with the step 304. Adjusting the angle at which the cable 312 couples with the step 304 adjusts a moment arm of the step 304.

Referring to FIGS. 9-10 and 16, the elongated members 328 include openings 338 through which a pin of the hinge 314 can be inserted. The step 304 can include hinge members 340 that are positioned on the outwards surfaces of the elongated members 328. The hinge member 340 can be female members including a corresponding opening that are configured to receive a pin that rotatably couples the step 304 with the elongated members 328 via the openings 338.

Referring to FIGS. 5-6, 9-10, and 12-13, and 16, the frame 302 can include medial coupling members 342 that extend outwards from the outer surfaces of the elongated members 328. The medial coupling members 342 are configured to couple the deployable step assembly 300 with the middle rail 160. The medial coupling members 342 can be positioned on the elongated members 328 at a vertical position between the pulley 318 and the hinge 314. The medial coupling members 342 can include an opening that is configured to receive a fastener to couple the medial coupling members 342 (e.g., the frame 302) with the middle rails 160.

Referring to FIGS. 5-6, 9-10, and 12-16, the frame 302 can include upper coupling members 344. The upper coupling members 344 are disposed on a top surface of the upper cross-member 330 and protrude in an upwards direction. In particular, the upper coupling members 344 can be positioned on the top surface of the upper cross-member 330 at corners of the upper cross-member 330. The upper coupling members 344 are configured to couple the frame 302 with the top rail 162. In some embodiments, the upper coupling members 344 include openings configured to receive fasteners to couple the top rail 162 with the frame 302.

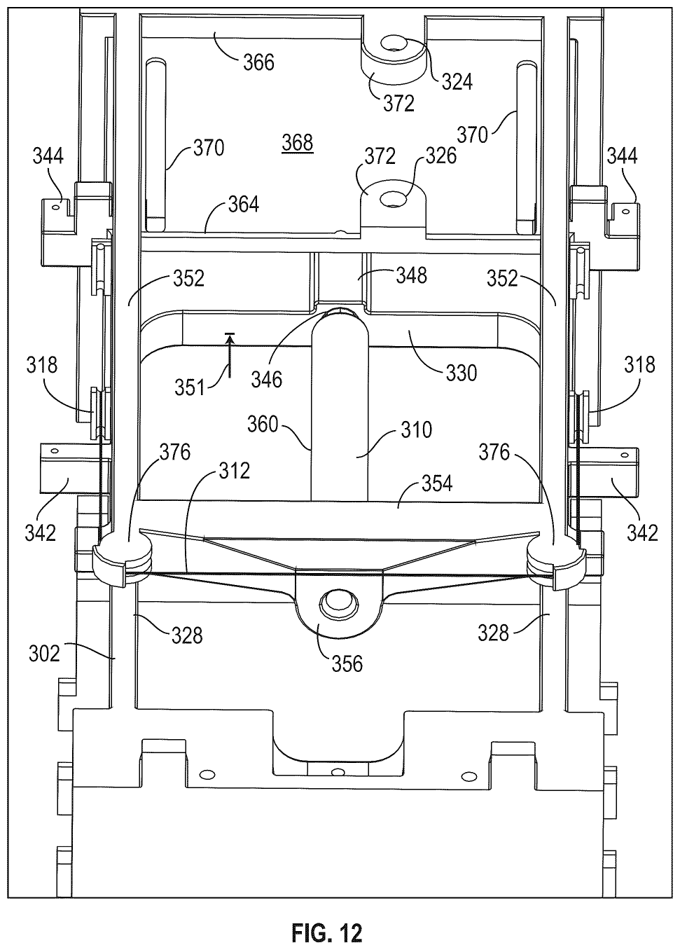

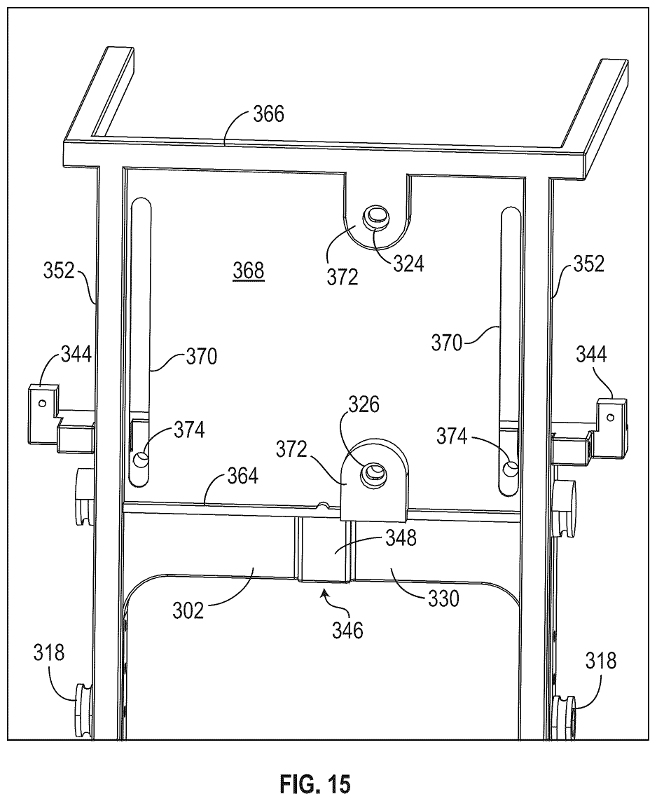

Referring to FIGS. 12 and 15, the upper cross-member 330 includes a medial portion 348 that is configured to receive a rod 362 of the gas shock 310 through an opening 346 of a bottom surface 351 of the upper cross-member 330. The medial portion 348 defines a space within which the rod 362 of the gas shock 310 can be received. The rod 362 of the gas shock 310 is configured to be received within and fixed (e.g., push against) to the upper cross-member 330.

Referring to FIGS. 9-10 and 12-13, the movable member 306 includes a pair of elongated members 352 (e.g., frame members, tubes, rails, channels, etc.). The movable member 306 includes a bottom cross-member 354, a medial cross-member 364, and an upper cross-member 366. The upper cross-member 366 can be one of the frame rails 316. The bottom cross-member 354, the medial cross-member 364, and the upper cross-member 366 extend between the movable members 306. The bottom cross-member 354 includes a receiver 356 (e.g., an opening) that defines a space 358 within which an end of a body 360 of the gas shock 310 is received. The bottom cross-member 354 is configured to engage the bottom of the body 360 of the gas shock 310 (e.g., the cap end of the gas shock 310).

The movable member 306 also includes a plate 368 (e.g., a body, a surface, a face, etc.) that extends between the elongated members 352, the medial cross-member 364 and the upper cross-member 366. The medial cross-member 364 and the upper cross-member 366 can include bosses 372 (e.g., a reinforced portion) that define the second opening 326 and the first opening 324, respectively. In some embodiments, the bosses 372 is integrally formed with the medial cross-member 364 and the upper cross-member 366. The boss 372 of the medial cross-member 364 and the second opening 326 are disposed above the medial cross-member 364. The boss 372 and the first opening 324 are disposed below the upper cross-member 366.

The plate 368 includes a pair of slots 370 disposed proximate the elongated members 352. As shown in FIG. 15, a pair of openings 374 of the frame 302 (e.g., defined through the upper cross-member 330 of the frame 302) are aligned with the slots 370. The pair of openings 374 are configured to receive a pair of fasteners or pins that extend through the openings 374 and the slots 370 to slidably couple the movable member 306 with the frame 302. The slots 370 can facilitate proper alignment and guidance of the movable member 306 relative to the frame 302.

Referring to FIG. 12, among others, the movable member 306 includes a pair of cable engagement members 376 (e.g., pulleys, rollers, cylindrical members with grooves, etc.) disposed on a bottom of the bottom cross-member 354. The cable engagement members 376 can protrude in a downwards direction from a bottom surface of the bottom cross-member 354. The cable 312 can extend downwards from the pulleys 318 and wrap around the cable engagement members 376. The cable engagement members 376 can include grooves or channels configured to receive the cable 312.

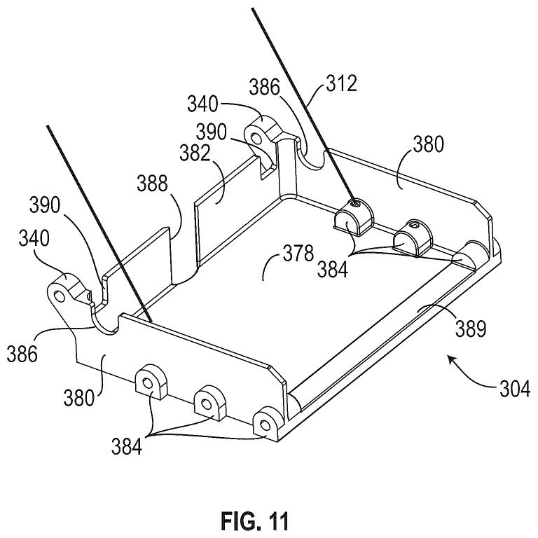

Referring to FIG. 11, among others, the step 304 includes a floor 378 (e.g., a base, a support surface, a bottom, etc.), side walls 380, and a rear wall 382. The side walls 380 and the rear wall 382 extend upwards from the floor 378. The step 304 includes an open end opposite the rear wall 382. The step 304 includes an edge 389 along the open end that protrudes upwards above the floor 378. The hinge members 340 are disposed at corners of the step 304 between the side walls 380 and the rear wall 382. The rear wall 382 includes a medial slot 388 (e.g., an opening, a space) that is located centrally along the rear wall 382 between the side walls 380. The medial slot 388 is positioned and sized such that clearance is provided between the step 304 and the body 360 of the gas shock 310 when the step 304 is transitioned into the stowed position. The rear wall 382 also includes a pair of slots 390 disposed adjacent the hinge members 340. The slots 390 are positioned and sized to provide clearance between the rear wall 382 of the step 304 and the elongated members 328 of the frame 302 when the step 304 is transitioned into the stowed position. The side walls 380 include slots 386 disposed proximate (e.g., adjacent) the hinge members 340. The slots 386 are positioned and sized such that clearance is provided between the side walls 380 and the medial coupling members 342 of the frame 302 when the step 304 is transitioned into the stowed position. The hinge members 340 can protrude rearwardly from the rear wall 382.

Referring still to FIG. 11, the step 304 can include multiple cable interfacing portions 384 (e.g., bosses, protrusions, etc.). The cable interfacing portions 384 can be disposed along the floor 378 at the corner between the floor 378 and the side walls 380. The cable interfacing portions 384 are configured to receive ends of the cable 312 to couple the cable 312 with the step 304. The cable 312 can be adjustable to couple with various of the cable interfacing portions 384. The cable interfacing portions 384 can include apertures configured to receive ends of the cable 312.

Referring to FIGS. 10-12, the cable 312 can be a single continuous cable. The cable 312 can extend from a first of the cable interfacing portions 384, up to a first of the pulleys 318, down and around a first of the cable engagement members 376, across the bottom of the bottom cross-member 354, around a second of the cable engagement members 376 (e.g., on an opposite side of the movable member 306), up to a second of the pulleys 318 (e.g., at an opposite side of the frame 302), and down to a second of the cable interfacing portions 384 on an opposite side of the step 304. In some embodiments, the cable 312 is provided as two separate cables that each extend from one of the cable interfacing portions 384, around the corresponding pulley 318, and are fixed with the movable member 306 (e.g., at the cable engagement members 376).

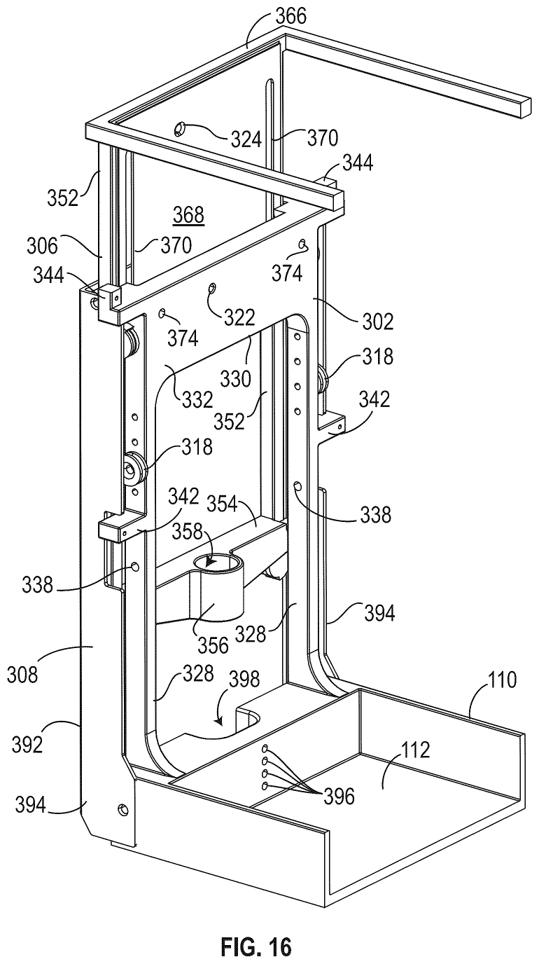

Referring to FIG. 16, the housing 308 includes a main portion 392 and side portions 394 that protrude from opposite ends of the main portion 392. The side portions 394 can extend along and be coupled to outer sides of the base 110. The main portion 392 extends vertically from the base 110 to an upper end of the frame 302. The housing 308 and the frame 302 define a space therebetween within which the movable member 306 is disposed.

Referring still to FIG. 16, the base 110 can include a recess 398 and a plurality of openings 396 that protrude through the base 110. The recess 398 is sized, positioned, and provided to provide clearance for the receiver 356 when the movable member 306 is translated into a lowest position (e.g., in the stowed position). The openings 396 are provided to receive a pin at a variety of vertical positions in order to limit an amount of downwards motion that the movable member 306 can travel while translating downwards. For example, the pin may be inserted into one of the openings 396 in order to limit the step 304 from transitioning fully into the stowed position.

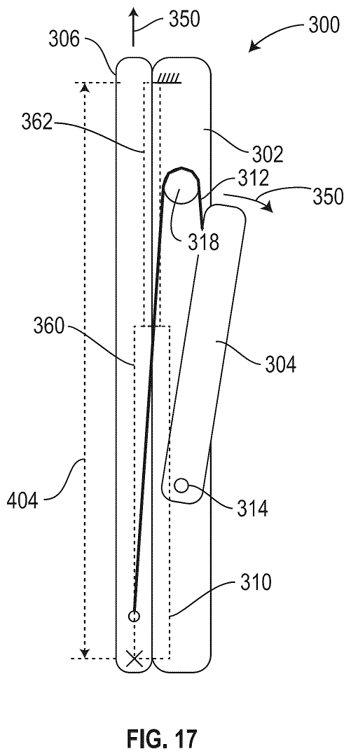

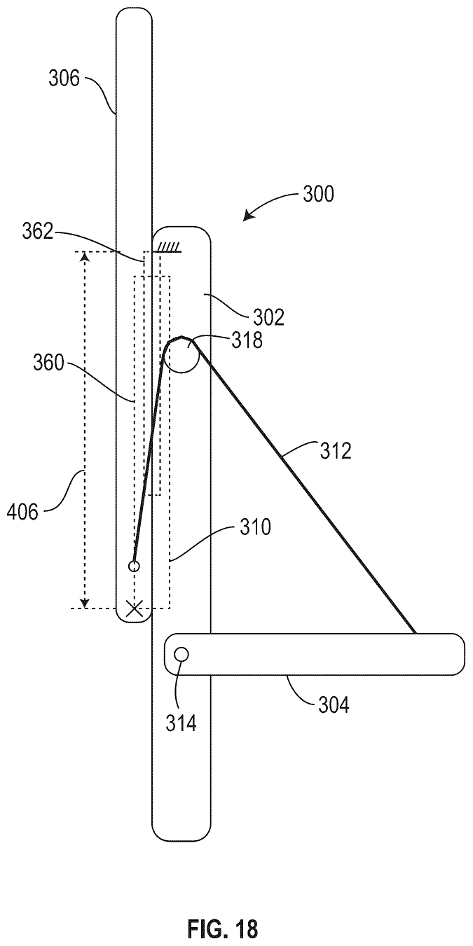

Referring to FIGS. 17 and 18, a diagram of the deployable step assembly 300 shows operation of the deployable step assembly 300 as the step 304 is transitioned from the stowed position to the deployed position and vice versa. When the step 304 is in the stowed position as shown in FIG. 17, the gas shock 310 is in the de-energized state and has an overall length 404. As the step 304 is rotated about the hinge 314, the cable 312 pulls the movable member 306 relative to the frame 302 in the upwards direction 350, thereby causing the gas shock 310 to compress. Once the step 304 has reached the fully deployed position as shown in FIG. 18, the gas shock 310 has an overall length 406 that is less than the overall length 404. The gas shock 310 is in a compressed or energized state when the step 304 is in the deployed position as shown in FIG. 18. Once the movable member 306 is released from the frame 302 and free to move relative to the frame 302 (e.g., a pin is removed or a locking mechanism is unlocked), the gas shock 310 drives motion of the movable member 306 in a downwards direction relative to the frame 302. The motion of the movable member 306 in the downward direction drives motion of the step 304 by pulling the step 304 into the stowed position through the cable 312.

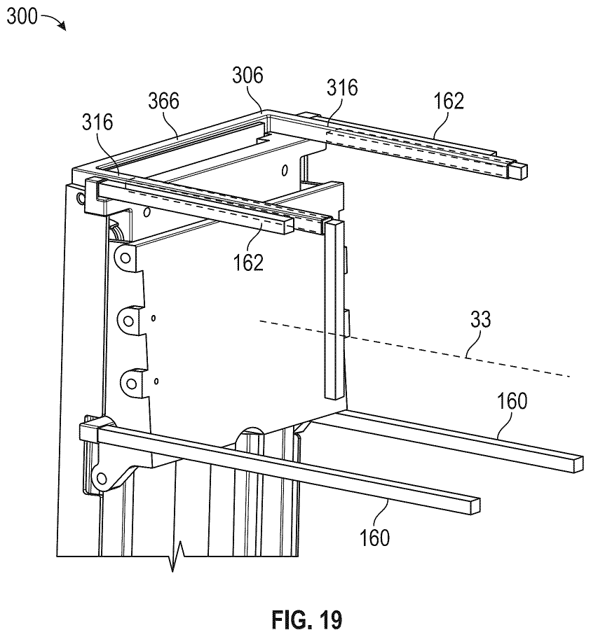

Referring to FIGS. 19-23, the movable member 306 includes the frame rails 316 protruding in multiple directions from the upper cross-member 366. The frame rails include an extendable frame rail 408 that is extendable from and retractable into the frame rails 316. The frame rails 316 can extend in a longitudinal direction. The extendable frame rail 408 includes portions that extend longitudinally into inner volumes 410 of the frame rails 316, and a portion that extends laterally. The extendable frame rail 408 can have a U-shape, with ends of the U-shape configured to be received within the inner volumes 410 of the frame rails 316.

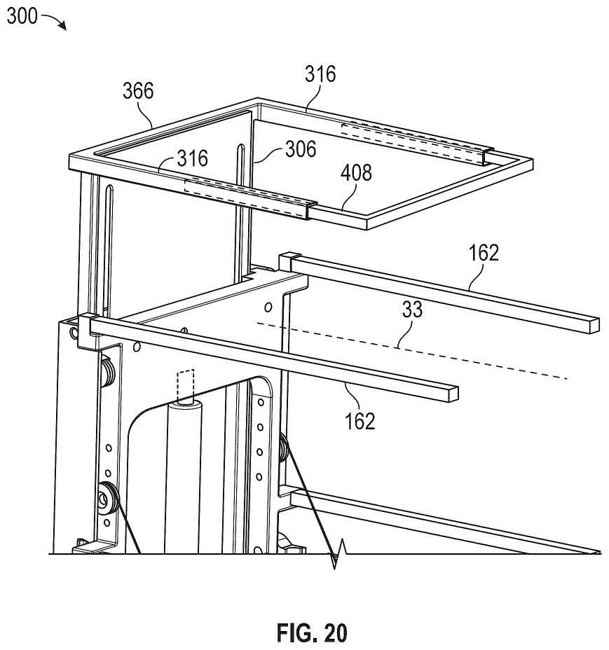

As shown in FIGS. 19 and 20, the extendable frame rail 408 can be transitionable (e.g., rotatable) between a closed position (shown in FIG. 20) and an open position (shown in FIG. 19). Depending on the configuration, the extendable frame rail 408 can be rotated upwards or downwards to transition out of the closed position and into the open position. The extendable frame rail 408 can be rotated (e.g., by hand) into the open position so that a user can enter an area within the frame rails 316. The extendable frame rail 408 can be rotated (e.g., by hand) back into the closed position so that the user can perform work while being within the area within the frame rails 316. The frame rails 316, the extendable frame rail 408, and the upper cross-member 366 can define a closed perimeter (e.g., a cage) and rails for the user to grasp on all four sides.

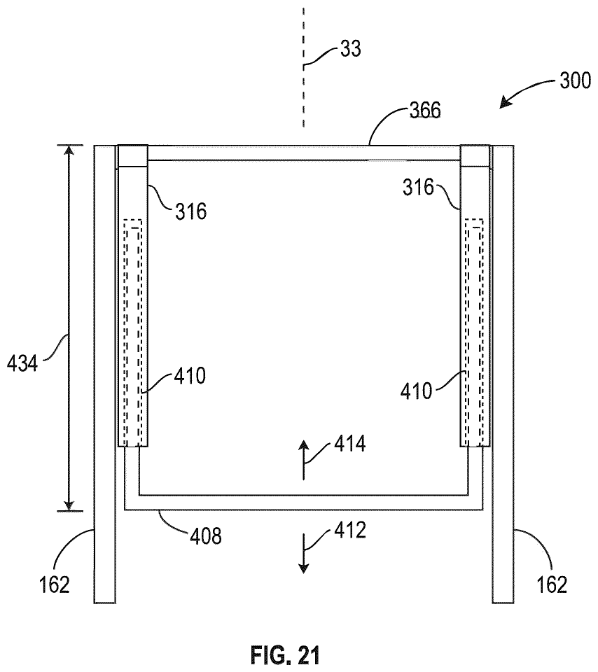

Referring to FIG. 21, the extendable frame rail 408 can be moved (e.g., extended out of or retracted into) the rails 316 in either an outwards direction 412 or an inwards direction 414. When the extendable frame rail 408 is moved in the outwards direction 412, the portions of the extendable frame rail 408 are extended from the inner volume 410 of the frame rails 316. When the extendable frame rail 408 is moved in the inwards direction 414, the portions of the extendable frame rail 408 are retracted into the inner volumes 410 of the frame rails 316. Moving the extendable frame rail 408 in the outwards direction 412 increases an overall size of the area within the frame rails 316, the extendable frame rail 408, and the upper cross-member 366. Likewise, moving the extendable frame rail 408 in the inwards direction 414 decreases the overall size of the area within the frame rails 316. In some embodiments, the extendable frame rail 408 can be positioned (e.g., moved in the outwards direction 412 or the inwards direction 414) prior to deploying the step 304. For example, if an area overhead of the deployable platform assembly 300 has a small area, the extendable frame rail 408 can be moved in the inwards direction 414 such that an overall length 434 of the frame rails 316 and the extendable frame rail 408 can fit within the small area. Likewise, if there is no space constraint in the vicinity immediately above the deployable platform assembly 300, the extendable frame rail 408 can be moved in the outwards direction 412 to a desired position.

As shown in FIG. 21, the extendable frame rail 408 is received within and configured to telescope relative to the frame rails 316 in a pair of directions (e.g., the inwards direction 414 and the outwards direction 412) along the longitudinal axis 33. In some embodiments, the extendable frame rail 408 is configured to be extended or retracted relative to the frame rails 316 in directions along the lateral axis. For example, the upper cross-member 366 can have an inner volume configured to receive one of the portions of the extendable frame rail 408 in order to allow telescoping of the extendable frame rail 408 along the lateral axis LT. In some embodiments, the deployable step assembly 300 includes multiple extendable frame rails 408 such that the frame rails 316 can be increased or decreased in size in multiple directions (e.g., along both the longitudinal axis and the lateral axis).

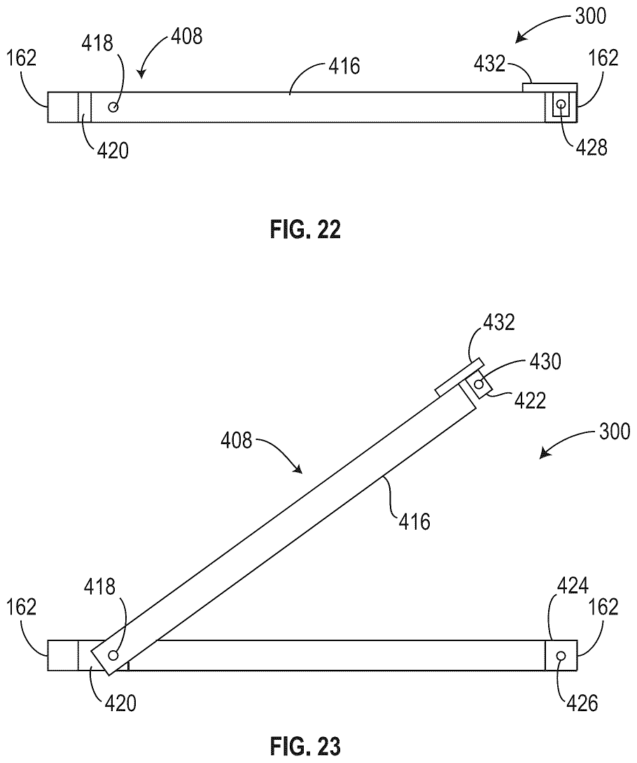

Referring to FIGS. 22 and 23, the extendable frame rail 408 can include a pivotal member 416 that is rotatable relative to a fixed member 420 of the extendable frame rail 408. The fixed member 420 can be integrally formed or otherwise fixedly coupled with one of the portions of the extendable frame rail 408 that are received within and extendable relative to the inner volume 410 of the frame rails 316. The pivotal member 416 is pivotally coupled with the fixed member 420 (e.g., through a pin 418) such that the pivotal member 416 is rotatable relative to the fixed member 420. The pivotal member 416 can be rotated between a closed position (shown in FIG. 22) and an open position (e.g., a partially open position as shown in FIG. 23) relative to the fixed member 420.

As shown in FIGS. 22 and 23, the pivotal member 416 can include a pin 428. The pin 428 can be spring loaded or manually removable and insertable. The pin 428 limits movement of the pivotal member 416 out of the closed position when inserted. The pin 428 can be received within an opening 426 in a fixed member 424 of the extendable frame rail 408 that is opposite the fixed member 420 at which the pivot point of the pivotal member 416 is defined. The pin 428 can also be received within an opening 430 of a member 422 disposed at a free end of the pivotal member 416. The pin 428 therefore locks the pivotal member with the fixed member 424 in the closed position. It should be understood that the pin 428 is not intended to be limiting, and that the free end of the pivotal member 416 can be otherwise coupled with the fixed member 424.

As shown in FIGS. 22 and 23, the pivotal member 416 can include a member 432 that is configured to extend over a top surface of the fixed member 424 when the pivotal member 416 is in the closed position shown in FIG. 22. The member 432 can directly contact or abut the top surface of the fixed member 424. The member 432 limits further movement of the pivotal member 416 about the pin 418 (e.g., the hinged coupling) to provide a stop for the pivotal member 416.

The pivotal member 416 is shown configured to pivot upwards to transition into the open position. It should be understood that the pivotal member 416 can also be configured to pivot downwards to transition into the open position. For example, the member 432 can be configured to abut a bottom surface of the fixed member 424 when the pivotal member 416 is transitioned into the closed position. The pivotal member 416 can therefore be rotated in a downwards direction and then in an upwards direction to transition the pivotal member 416 into the open position and then the closed position. The pivotal member 416 can be defined on a longitudinal end or a lateral end of the frame rails 316.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device platforms and decks as shown in the various exemplary embodiments are illustrative only. Additionally, any element disclosed in one embodiment may be incorporated or utilized with any other embodiment disclosed herein.

What is claimed is:

1. A deck apparatus for a lift device, the deck apparatus comprising:
a frame;
a deck pivotally coupled with the frame;
a member coupled with the frame and configured to translate along the frame in an upwards direction or a downwards direction;
a plurality of rails coupled to an upper end of the member, the plurality of rails defining a perimeter and coupled with the upper end of the member at a pair of corners, wherein the plurality of rails comprise:
outer members; and
an extendable rail comprising ends configured to be received within inner volumes of the outer members, the extendable rail configured to be extended from or retracted into the outer members to adjust a length of the perimeter of the plurality of rails.

2. The deck apparatus of claim 1, wherein the extendable rail comprises a pivotal member hingedly coupled with a first portion of the extendable rail, the pivotal member configured to be pivoted between a closed position in which a free end of the pivotal member engages a second portion of the extendable rail and an open position in which the free end of the pivotal member does not engage the second portion of the extendable rail.

3. The deck apparatus of claim 2, further comprising a pin configured to couple the free end of the pivotal member with the second portion of the extendable rail.

4. The deck apparatus of claim 1, further comprising:
a cable configured to operably couple the deck with the member; and
a cylinder coupled with the frame and the member;
wherein the deck is pivotable between a stowed position and a deployed position, wherein pivoting of the deck from the stowed position to the deployed position drives translation of the member along the frame in the upwards direction.

5. The deck apparatus of claim 4, wherein the member comprises a body extending in the upwards direction and a plurality of rails extending in a plane that is substantially perpendicular with the upwards direction.

6. The deck apparatus of claim 4, wherein the cylinder is configured to bias the member in the downwards direction and the deck into the stowed position.

7. The deck apparatus of claim 4, wherein the deck apparatus is an end of a platform assembly of the lift device.

8. The deck apparatus of claim 4, wherein the deck apparatus is coupled to a plurality of rails at an end of a platform assembly of the lift device.

9. The deck apparatus of claim 4, further comprising a pulley, wherein the pulley is rotatably coupled with the frame and the cable is received within a groove of the pulley.

10. The deck apparatus of claim 4, further comprising a housing disposed on a first side of the frame, the deck protruding from a second side of the frame, wherein the housing and the frame define a space therebetween within which the member is positioned.

11. The deck apparatus of claim 4, further comprising a pin, the pin configured to be inserted into an opening in the frame and one of a plurality of openings formed in the member to lock the member at an upper or a lower position relative to the frame.

12. A lift vehicle, comprising:
a chassis;
a lift apparatus coupled with the chassis;
a platform assembly coupled with the lift apparatus; and
a deck apparatus coupled to the platform assembly, the deck apparatus comprising:
a frame;
a deck pivotally coupled with the frame;
a member coupled with the frame and configured to translate along the frame in an upwards direction or a downwards direction;
a plurality of rails coupled to an upper end of the member, the plurality of rails defining a perimeter and coupled with the upper end of the member at a pair of corners, wherein the plurality of rails comprise:
outer members; and
an extendable rail comprising ends configured to be received within inner volumes of the outer members, the extendable rail configured to be extended from or retracted into the outer members to adjust a length of the perimeter of the plurality of rails.

13. The lift vehicle of claim 12, wherein the extendable rail comprises a pivotal member hingedly coupled with a first portion of the extendable rail, the pivotal member configured to be pivoted between a closed position in which a free end of the pivotal member engages a second portion of the extendable rail and an open position in which the free end of the pivotal member does not engage the second portion of the extendable rail.

14. The lift vehicle of claim 13, wherein the deck apparatus further comprises a pin configured to couple the free end of the pivotal member with the second portion of the extendable rail.

15. The lift vehicle of claim 12, wherein the deck apparatus further comprises:
a cable configured to operably couple the deck with the member; and
a cylinder coupled with the frame and the member;
wherein the deck is pivotable between a stowed position and a deployed position, wherein pivoting of the deck from the stowed position to the deployed position drives translation of the member along the frame in the upwards direction.

16. A platform assembly for a lift vehicle, the platform assembly comprising:
a base; and
a deck apparatus, comprising:
a frame;
a deck pivotally coupled with the frame;
a member coupled with the frame and configured to translate along the frame in an upwards direction or a downwards direction;
a plurality of rails coupled to an upper end of the member, the plurality of rails defining a perimeter and coupled with the upper end of the member at a pair of corners, wherein the plurality of rails comprise:
outer members; and
an extendable rail comprising ends configured to be received within inner volumes of the outer members, the extendable rail configured to be extended from or retracted into the outer members to adjust a length of the perimeter of the plurality of rails.

17. The platform assembly of claim 16, wherein the extendable rail comprises a pivotal member hingedly coupled with a first portion of the extendable rail, the pivotal member configured to be pivoted between a closed position in which a free end of the pivotal member engages a second portion of the extendable rail and an open position in which the free end of the pivotal member does not engage the second portion of the extendable rail.

18. The platform assembly of claim 17, further comprising a pin configured to couple the free end of the pivotal member with the second portion of the extendable rail.

19. The platform assembly of claim 16, further comprising:
a cable configured to operably couple the deck with the member; and
a cylinder coupled with the frame and the member;
wherein the deck is pivotable between a stowed position and a deployed position, wherein pivoting of the deck from the stowed position to the deployed position drives translation of the member along the frame in the upwards direction.

20. The platform assembly of claim 16, wherein the extendable rail is positioned above a fixed rail of the platform assembly, the extendable rail extending in a direction parallel with the fixed rail.
